(19) United States
(12) Patent Application Publication
(10) Pub. No.: US 2008/0161628 A1
(43) Pub. Date: Jul. 3, 2008

(54) Apparatus for Nuclear Waste Disposal, Method for Manufacturing and Installing the Same

(76) Inventor: Kyung Yeon Jo, Jeju-si (KR)

Correspondence Address: H.C. PARK & ASSOCIATES, PLC, 8500 LEESBURG PIKE, SUITE 7500, VIENNA, VA, 22182, US

(21) Appl. No.: 11/816,115

(22) PCT Filed: Feb. 13, 2006
(86) PCT No.: PCT/KR2006/000510

§ 371 Date: Aug. 13, 2007

(30) Foreign Application Priority Data
Feb. 12, 2005 (KR) 10-2005-0011712

(51) Int. Cl. G21F 1/04

(52) U.S. Cl. 588/3

(57) ABSTRACT

The present invention relates to a nuclear waste disposal apparatus, a method of manufacturing the same, and a method of installing the same. The apparatus is manufactured by packing nuclear waste into a vessel, installing the vessel into a ring-shaped elastic body such as a discarded tire used on a truck or a large-sized bus, covering the vessel storing the nuclear waste therein with high-strength reinforced concrete, and installing pieces of structural steel in a space of the elastic body so that the apparatus can endure heavy loads and natural disasters such as earthquakes.

### TECHNICAL FIELD

The present invention relates to an apparatus for disposing of nuclear waste, and a method of manufacturing the same. More particularly, the present invention relates to a nuclear waste disposal apparatus and a method for manufacturing the same, the apparatus having a perfect radiation shielding and sealing structure and structural safety because nuclear waste generated from nuclear power plants or atomic energy research institutes is put into ring-shaped elastic bodies such as waste tires, the nuclear waste is covered with ultra-high-strength reinforced concrete to shield the nuclear waste, and structural steel is installed in the concrete in the vertical direction and the horizontal direction in order to enhance the durability of the apparatus against a heavy load and natural disasters such as earthquakes.

### BACKGROUND ART

Generally, nuclear power is an energy produced when the state of an atomic nucleus is changed, and is also called atomic energy or nucleus energy. A nuclear power plant artificially produces such nuclear power by artificially transforming an atomic nucleus of a material. The method of producing nuclear power is classified into a nuclear fission, in which an atomic nucleus of a heavy material such as uranium or plutonium fissions in series, and a nuclear fusion, in which atomic nuclei of a light material, such as heavy hydrogen, are fused.

The early days of atomic bombs and nuclear reactors used the nuclear fission, and hydrogen bombs use the nuclear fusion.

The term “nuclear waste” means byproducts produced when nuclear power plants or nuclear power research institutes are operated. Nuclear Waste is highly radioactive because it is a byproduct generated during nuclear fission in a nuclear reactor of a nuclear power plant, and it continuously creates heat even after the completion of the nuclear fission. That is, nuclear waste is used nuclear fuel, and is classified into high-level waste, which means the remnants after the nuclear fission of the nuclear fuel, other than uranium and plutonium, which can be reused, and low-level and middle-level waste, which means the remnants after liquid waste processing and items used by operators to handle the high-level waste, such as clothes, gloves and other components.

Since nuclear waste contains a large amount of radioactive material, and such radioactive material can rapidly propagate into the environment via wind and water, even if the nuclear waste is released into the air for just a few seconds, it is fatal to humans. This has sparked endless debates about the disposal of the nuclear waste because it cannot be guaranteed that nuclear waste stored and sealed in a disposal vessel is safe when stored deep underground.

In Korea, nuclear waste is divided into light-water reactor waste and heavy-water reactor waste.

Nuclear waste is stored in water as soon as it is discharged from a nuclear reactor in order to reduce the amount of heat and the level of radiation. Nuclear waste cooled in water for one year has a caloric value of about 12 kw/tonU and an amount of radiation of 2700 kCi/tonU, but those values represent reductions to about 3/1,000 times initial values thereof, compared to immediately after being discharged from the nuclear reactor.

Since radiation from the nuclear waste cannot be extinguished by chemical reaction, there is no solution for treating nuclear waste but to wait for the radioactivity of the nuclear waste to diminish naturally. Accordingly, it is the task of current societies to devise a method of permanently and safely storing nuclear waste.

In order to solve this problem, most of the countries adopt a method of burying the nuclear waste deep underground after putting it into a vessel treated by a predetermined method and sealing it.

That is, in order to more safely manage the nuclear waste, solid nuclear waste is pressed at ultra-high pressure and is stored in a drum. Liquid nuclear waste is processed according to the following sequence: vaporizing the liquid nuclear waste in order to reduce the volume thereof, solidifying the liquid nuclear waste by mixing the liquid nuclear waste with cement, and putting the solidified waste into a drum, and sealing the drum. The drum is stored in a storage tank. Gaseous nuclear waste is stored in a sealed tank until the degree of radiation thereof has decreased to a predetermined level, and then it is exhausted into the air through a high efficiency particulate filter.

In Korea, 12 nuclear power plants were operating by 1997, since the first nuclear power plant was built in 1978. Therefore, by May 1997, 48436 drums, 200 L per drum, of middle and low-level nuclear waste were accumulated and stored. Nuclear waste is temporarily stored at the nuclear power plant sites, but the current facilities for storing the nuclear waste will be filled to capacity by 2008.

Further, it is expected that the amount of nuclear waste will increase further since medical institutes and industries are increasingly using a radioactive isotopes and new nuclear power plants are being built. Accordingly, although the nuclear waste is currently temporarily and safely stored in storage tanks in nuclear power plants, problems with nuclear waste are arising from the viewpoints of limited storage capacity and storage site management.

The nuclear waste was first generated from the military purposes such as nuclear testing, but nowadays the amount of the nuclear waste generated from civil nuclear power plants has surpassed that of the nuclear waste generated from military use. Further, the total accumulated amount of the nuclear waste is sharply increasing.

On the other hand, sea dumping of nuclear waste was banned worldwide by a treaty signed at the London Convention in 1996. However, the London Convention treaty does not ban all nuclear waste, but allows sea dumping of seven items.

This treaty was made in order to avoid sea water pollution that can be caused by the rusting of steel vessels storing nuclear waste, dumped into the sea. Accordingly, in order to solve this problem, the steel vessels holding the nuclear waste therein were dumped into the sea, packed in steel containers. However, the steel container also has the problem of causing sea water pollution because it is also rusted by sea water.

Consequently, in most of countries, a method of storing nuclear waste and a method of building facilities to safely bury the nuclear waste remain as unsolved problems. Accordingly, it is a matter of urgency to solve the problems of safely disposing of and storing the nuclear waste for all countries worldwide.

### DISCLOSURE

### Technical Problem

Accordingly, the present invention has been devised in consideration of the aforementioned problems and situations, and it is an object of the present invention to provide an apparatus for disposal of nuclear waste and a method of manufacturing the same, the apparatus having a perfect shielding structure and structural safety because nuclear waste generated from nuclear power plants or atomic energy research institutes is put into ring-shaped elastic bodies such as discarded tires, ultra-high-strength reinforced concrete is applied to the nuclear waste to seal the nuclear waste, and structural steel is installed in the concrete in the vertical direction and the horizontal direction in order to enhance the durability of the apparatus with respect to a heavy load and natural disasters such as earthquakes. Accordingly, the apparatus can permanently and safely store nuclear waste. The apparatus has perfect radiation shielding, sealing structure, and structural safety. Since the apparatus is manufactured by reusing discarded tires and is designed not to be permeated by rainwater or seawater, the apparatus helps protect the environmental. For this reason, additional storage tanks or caves are not needed to store this apparatus, but this apparatus can be stored on land as it is, therefore it is possible to reduce construction and disposal costs. Further, when the apparatus is disposed of in the sea, the apparatus provides fish with habitat and sea weed with places on which to grow, so that the apparatus is beneficial to fisheries. Accordingly, the apparatus can be disposed of on land and in the sea.

In order to achieve the above objects and advantages, according to one aspect of the present invention, there is provided a nuclear waste disposal apparatus comprising a plurality of ring-shaped elastic bodies, each with a central through hole, stacked in a vertical direction, a plurality of vessels, each storing nuclear waste therein, stacked in a space provided by the central holes of the elastic bodies, and ultra-high-strength reinforced concrete covering the vessels in the space.

Plate-shaped covers may be coupled to the upper surface of an uppermost elastic body and the lower surface of a lowermost elastic body by respective coupling means.

Outer surfaces of the stacked elastic bodies and the covers may be coated with a waterproof agent.

Alternatively, outer surfaces of the stacked elastic bodies and the covers may be coated with a waterproof agent by a polyurea lining method.

In a variation, stone powder may be adhered onto the outer surfaces of the stacked elastic bodies and the covers.

The ring-shaped elastic bodies may be discarded tires used by trucks or large buses.

On the inside of the elastic bodies, along edges thereof, a plurality of pieces of structural steel may be installed in the vertical direction and the horizontal direction.

The pieces of structural steel may be coated with epoxy.

In order to achieve the above object and advantages, according to further aspect of the present invention, there is provided a method of manufacturing a nuclear waste disposal apparatus including ring-shaped elastic bodies, storing vessels and reinforced concrete, comprising the steps of stacking a plurality of ring-shaped elastic bodies in the vertical direction, installing vessels storing nuclear waste therein in a space defined by central holes of the elastic bodies, injecting reinforced concrete into the space defined by the central holes of the elastic bodies to seal the vessels, curing the reinforced concrete, coupling covers to an upper and lower surface of an uppermost and lowermost elastic body, respectively, and coating outer surfaces of the stacked elastic bodies and the covers with a waterproof material.

Preferably, the method may further comprise the step of installing pieces of structural steel in the vertical direction and the horizontal direction in the space defined by the central holes of the stacked elastic bodies.

The outer surfaces of the stacked elastic bodies and the covers may be covered with stone powder by an adhesion method.

In order to achieve the above objects and advantages, according to a still further aspect of the present invention, there is provided a method of installing a nuclear waste disposal apparatus comprised of ring-shaped elastic bodies and ultra-high-strength reinforced concrete comprising the steps of arranging a plurality of the apparatuses on a clay layer 10 meters below the ground surface, sealing the apparatus with a soil mixture of clay and lime, and topping the soil mixture with general soil.

Preferably, the plurality of nuclear waste disposal apparatuses may be connected to each other by a metal fixing means.

In order to achieve the above objects and advantages, according to yet a further aspect of the present invention, there is provided a method of installing a nuclear waste disposal apparatus comprised of ring-shaped elastic bodies and ultra-high-strength reinforced concrete comprising the steps of dumping a plurality of the apparatuses into sea, arranging the apparatuses in a row, and connecting the apparatuses to each other by a metal fixing means.

### ADVANTAGEOUS EFFECTS

The nuclear waste disposal apparatus having the above-mentioned construction is advantageous in that it can reuse discarded tires, used by trucks or large-sized buses, as elastic bodies for sealing and shielding nuclear waste. Further, the elastic bodies can prevent rainwater or seawater from permeating thereinto. Accordingly, the nuclear waste disposal apparatus is beneficial to the environment. The nuclear waste disposal apparatus has a complete radiation shielding structure because nuclear waste vessels storing nuclear waste are disposed inside ring-shaped elastic bodies such as discarded tires and the vessels are covered with high-strength reinforced concrete, and has structural safety because pieces of structural steel are installed in the vertical direction and the horizontal direction in the elastic bodies, so that the nuclear waste disposal apparatus can withstand heavy loads and natural disasters such as earthquakes, thereby enabling safe storage and transport of nuclear waste on land. Therefore, additional exclusive roads and seaports for carrying nuclear waste are not needed. Further, when the apparatus is used on land, additional storage tanks and caves are not needed. Accordingly, the nuclear waste disposal apparatus is beneficial from the aspect of economy. Further, when the apparatus is dumped in the sea, it provides habitat for fish and serves as a substrate on which seaweed can grow. Accordingly, the apparatus is beneficial to fisheries.

### DESCRIPTION OF DRAWINGS

FIG. 1 is a perspective view illustrating a nuclear waste disposal apparatus according to one embodiment of the present invention;

FIG. 2 is an exploded perspective view illustrating a nuclear waste disposal apparatus according to the embodiment of the present invention;

FIG. 3 is a flowchart showing a method of manufacturing the nuclear waste disposal apparatus according to the present invention;

FIG. 4 is an exploded perspective view illustrating a nuclear waste disposal apparatus according to another embodiment of the present invention;

FIG. 5 is a schematic perspective view illustrating the nuclear waste disposal apparatus installed on land;

FIG. 6 is a schematic perspective view illustrating the nuclear waste disposal apparatus installed in the sea; and

FIG. 7 is a perspective view illustrating the nuclear waste disposal apparatus installed in the sea, on which seaweed is growing.

### BEST MODE

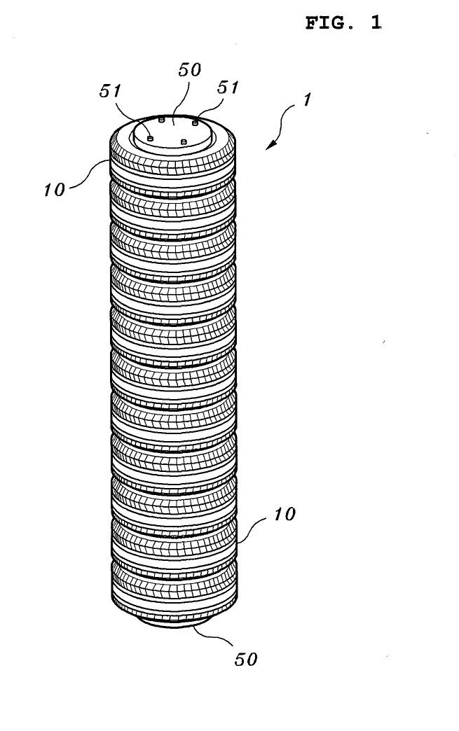

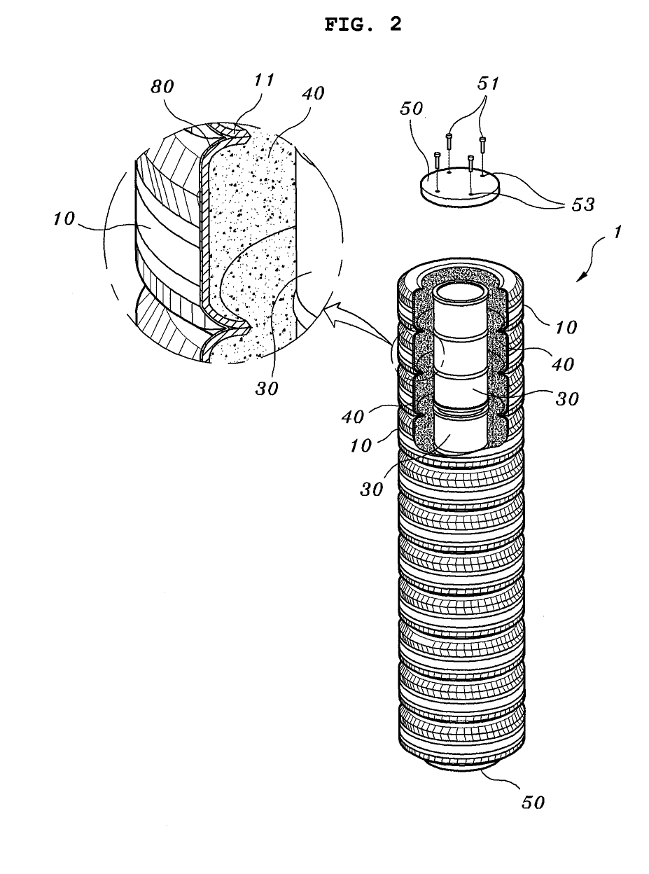

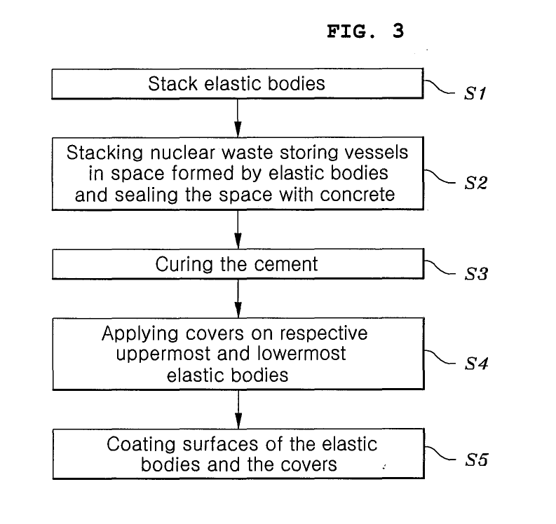

Hereinafter, the characteristics and other advantages of the present invention will be more apparent from the following description with reference to the accompanying drawings. FIG. 1 is a perspective view illustrating a nuclear waste disposal apparatus according to one embodiment of the present invention, FIG. 2 is an exploded perspective view illustrating a nuclear waste disposal apparatus according to one embodiment of the present invention, and FIG. 3 is a flowchart showing a method of manufacturing the nuclear waste disposal apparatus according to the present invention.

Referring to FIGS. 1 to 3, the nuclear waste disposal apparatus 1 according to the present invention comprises a plurality of elastic bodies 10, vessels 10 for storing nuclear waste therein, and high-strength reinforced concrete 40.

The elastic body 10 is made of rubber, and has a ring shape with a central circular through hole 11.

According to this embodiment, the elastic body 10 has a central circular hole 11 in the center thereof, but can alternatively have a polygonal through hole 11 instead of the circular hole 11.

Further, according to this embodiment, the elastic body 10 is a ring-shaped piece of rubber, but can be general tires or discarded tires having a ring shape and a central hole 11. The elastic body 10 can be made of synthetic resin containing rubber.

In the case that the elastic body 10 is implemented as a discarded tire, which has been used by vehicles and whose lifespan is ended, discarded tires used by trucks or large-sized buses are preferable to those used by general cars because the inner diameter and size are larger and the durability thereof is higher.

That is, discarded tiers used by trucks or large-sized buses, which have high rigidity, durability and impact absorptivity, and which are required to endure heavy load and the weight of vehicle itself at the top speed, are most suitable for the elastic body 10, so that the vessels 30 held in the elastic body 10 can better resist external pressure and impacts.

The vessels 30 are stacked in a space defined by the central through holes 11 of the elastic bodies 10, which are stacked, and the vessels 30 store nuclear waste generated in nuclear power plants and research institutes therein. The inner diameter and size of the elastic body 10 surrounding the vessel 30 are determined according to the diameter of the vessel 30.

Further, three or more vessels 30 are generally stacked in the space defined by the central holes 11 of the stacked elastic bodies 10, but the number of stacked vessels 30 may be less than or greater than three.

The height and the number of elastic bodies 10 which are stacked in the vertical direction preferably correspond to the height and the number of the vessels 30 installed in the inner space thereof.

The ultra-high-strength reinforced concrete 40 is injected into the space defined by the central holes 11 of the elastic bodies 10, and is cured therein. The concrete 40 may be special sea concrete having high strength.

According to this embodiment, the concrete applied in the inner space defined by the central holes 11 of the elastic bodies 10 stacked in the vertical direction and cured therein is high-strength reinforced concrete 40 or high-strength reinforced concrete for use in the sea. However, any concrete ingredients can be used if the concrete can shield and seal the vessels 30 installed in the space 11 defined by the central holes 11 of the elastic bodies 10 after it has been applied into the space 11 and cured.

Plate-shaped covers 50 are respectively coupled to the upper surface of an uppermost elastic body 10 and the lower surface of a lowermost elastic body 10 by a coupling means 51.

That is, the covers 50, having diameters corresponding to diameters of the spaces formed by the central holes 11 of the elastic bodies 10, are respectively provided to the uppermost elastic body 10 and the lowermost elastic body 10 of the elastic bodies stacked in the vertical direction in order to seal and shield the vessels 30 storing nuclear waste therein.

The covers 50 are fixed to the concrete 40 applied and cured in the spaces of the central holes 11 of the uppermost elastic body 10 and the lowermost elastic body 10 by a fixing means 51. For this, the covers 50 have a plurality of through holes 53 so that the covers are securely fixed to the concrete 40 by the fixing means 51.

The fixing means 51 has a predetermined length so that one end thereof is passed through the through hole 53 of the cover 50 and is combined with the cement hardened and cured in the space defined by the central hole 11 of the outermost elastic body 10.

The covers 50 are made of stainless steel in order to prevent rusting by groundwater or seawater when the apparatus is installed on land or in the sea, and the fixing means 51 is made of the same material as the covers 50.

According to this embodiment, the covers 50 have a plate shape, but are not limited thereto. For example, the cover 50 can comprise an upper plate part and a coupling part protruding from the surface of the upper plate part and having the same diameter as the diameter of the space defined by the circular hole 11 of the elastic body 10 in order to increase shielding and sealing capability between the covers and the outermost elastic bodies 10. The upper plate part has a diameter greater than that of the space 11 defined by the central hole 11 of the elastic body 10, so that the lower surface of the cover 50 comes into close contact with the upper surface of the elastic body 10, and the coupling part protruding from the surface of the upper plate part is inserted into the space in the central hole 11, so that the covers 50 can be tightly coupled to the elastic bodies.

According to this embodiment, the covers 50 are made of stainless steel, but may be made of synthetic resin or other materials as long as they can prevent rusting by groundwater or seawater.

Further, the outer surfaces of the elastic bodies 10 and the covers 50 are coated with a waterproof agent in order to enhance shielding and sealing ability of the vessels 30 for storing nuclear waste therein and preventing rusting by groundwater or seawater when the apparatus is installed on land or in the sea.

Epoxy is a preferable waterproof agent 80. According to the embodiment of the present invention, the outer surfaces of the elastic bodies 10 and the covers 50 are coated with epoxy, but can be coated with other materials as long as the materials can enhance shielding and sealing ability and prevent rusting by seawater. That is, the waterproof agent may be adequately selected from a variety of materials.

Alternatively, the outer surfaces of the elastic bodies 10 and the covers 50 can be coated with a polyurea layer, which does not react with moisture, seldom cracks and is difficult to detach from a surface once it is attached to the surface because it has high elasticity, through a lining process, so that corrosion of the nuclear waste disposal apparatus 1 can be prevented because germs cannot permeate into the nuclear waste disposal apparatus 1.

Hereinafter, a method of manufacturing a nuclear waste disposal apparatus will be described in detail.

First, a plurality of ring-shaped elastic bodies 10, each having a central through hole 11, is stacked to a predetermined height in the vertical direction (S1).

When stacking the ring-shaped elastic bodies 10, a plurality of supporting bars made of wood is provided to the outer surfaces of the elastic bodies 10 in order to maintain the straight vertical profile extending along the outer surface of the elastic bodies 10 and to prevent the elastic bodies from collapsing.

An inner space 11 is formed by extending the central holes 11 of the elastic bodies 10, and a plurality of vessels 30 storing nuclear waste therein is stacked in the inner space 11. Then, ultra-high-strength reinforced concrete 40 is injected into the inner space 11 to seal the vessels 30 (S2).

That is, after installing the vessels 30 in the inner space 11 formed by the central holes 11 of the elastic bodies 10 stacked in the vertical direction, the high-strength reinforced concrete 40 is applied around the vessels 30 and in the inner space 11 of the elastic bodies 10 using a vehicle such as ready mixed concrete truck, thereby completely shielding and sealing the vessels 30 storing the nuclear waste therein.

In this instance, since the concrete 40 is injected into the space 11 formed by extending the central holes 11 of the elastic bodies 10 and into respective empty inner spaces of the elastic bodies 10, the shielding and sealing effect is enhanced.

According to the embodiment of the present invention, first the vessels 30 storing nuclear waste therein are installed in the space 11 formed by extending the central holes 11 of the elastic bodies 10 and then the concrete 40 is injected into the space 11 and cured, but the present invention is not limited thereto. That is, the sequence can change. For example, the reinforced concrete 40 can be injected into the space 11 of the elastic bodies 10 first, and then the vessels 30 can be stacked in the space 11 before the concrete 40 is cured.

In this instance, the number of the vessels 30 stacked in the space 11 is preferably three, but may also be fewer or more.

The overall height of the stacked elastic bodies 10 is preferably equal to the overall height of the vessels 30.

Next, the injected concrete 40 is hardened and cured (S3). At this time, when hardening and curing the concrete 40, coupling force between the concrete 40 and the elastic bodies 10 is enhanced due to the expansion of the concrete 40, the recovery force generated by elasticity of the elastic bodies 10 surrounding the concrete 40, and the contraction force in reaction to the expansive force.

Next, covers 50 are coupled to the upper surface of the uppermost elastic body 10 and the lower surface of the lowermost elastic body 10, respectively (S4).

In this instance, the covers 50 are securely fixed to the concrete 40 by fixing means 51 and through holes 50 which are formed to penetrate the covers 50. The fixing means 51 engage with the through the holes 50 and are joined to the concrete 40.

Next, outer surfaces of the stacked elastic bodies 10 and the covers 50 are coated with a waterproof agent 80 (S15). Here, the waterproof agent 80 can be epoxy.

Thanks to the structure in which the outer surfaces of the elastic bodies 10 and the covers 50 are coated with a waterproof agent 80, the shielding and sealing ability of the nuclear waste disposal apparatus 1 is improved, and the apparatus 1 can be prevented from corroding.

In the nuclear waste disposal apparatus 1 having the above described structure and manufactured through the above described method, the nuclear waste stored in the vessels 30 is sealed primarily by the waterproof agent 80, secondarily by the thick elastic body 10, and thirdly by the high-strength reinforced concrete 40 injected into and cured in the elastic body 10. That is, the apparatus has a triple shielding and sealing stricture.

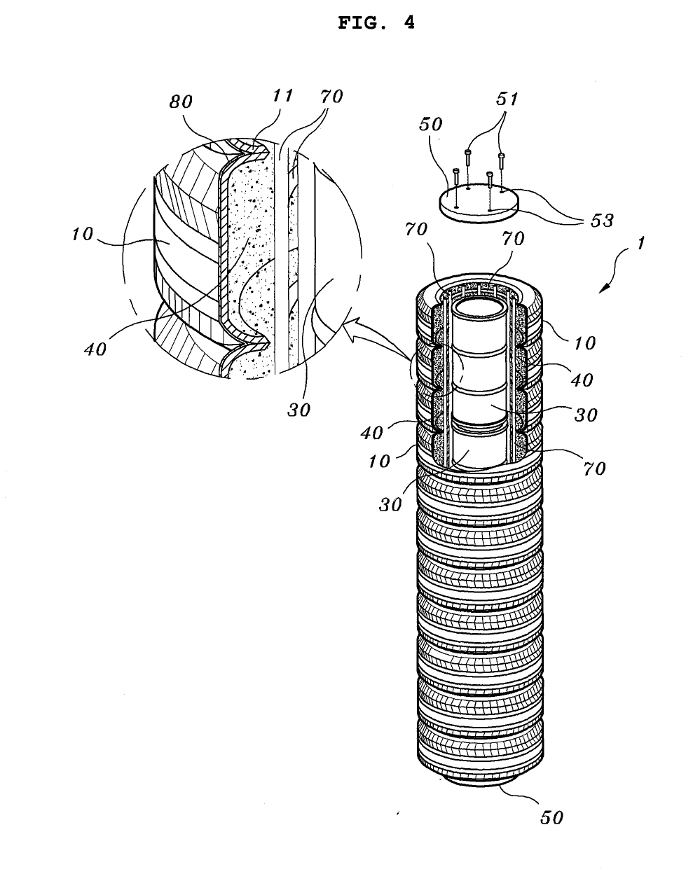

FIG. 4 is an exploded perspective view illustrating a nuclear waste disposal apparatus according to another embodiment of the present invention. The nuclear waste disposal apparatus according to the other embodiment of the present invention is described with reference to FIG. 4 and FIGS. 1 and 2.

Referring to FIG. 4, a plurality of ring-shaped elastic bodies 10 is stacked in the vertical direction. At this time, a space 11 is formed by central holes of the ring-shaped elastic bodies in the center of the stacked elastic bodies 10.

A plurality of vessels 30, each storing nuclear waste therein, is disposed in the space 11. Further, a plurality of pieces of structural steel 70 is provided in the space 11 between the inner circumferential edges of the ring-shaped elastic bodies 10 and the outer surfaces of the vessels 30.

The pieces of structural steel 70 have a ring shape and are installed in the vertical direction in the space formed by the central holes of the elastic bodies, between inner surfaces of the elastic bodies 10 and outer surfaces of the vessels 30.

The pieces of structural steel 70 installed between the inner surfaces of the elastic bodies 10 and the outer surfaces of the vessels 30 in the space 10 are combined with the concrete 40 hardened and cured therein, thereby enhancing the ability to shield and seal the vessels 30.

In this case, the pieces of structural steel 70 are first installed in the vertical direction in the space 11 formed in the center portions of the elastic bodies 10, the vessels 30 are then stacked inside the pieces of structural steel 70, and the concrete 40 is applied to the vessels 30, so that the concrete 70 is hardened and cured in the space 11 while combining with the pieces of structural steel 70.

The pieces of structural steel 70 are sized to fit the space 11 in the spot while being installed. Alternatively, the pieces of structural steel 70 are prepared to have a predetermined size before installation. The pieces of structural steel 70 preferably have a ring shape to provide space in a center portion thereof for receiving the vessel 30 storing nuclear waste in the space.

According to the embodiment of the present invention, although the pieces of structural steel 70 are first installed in the vertical direction in the space 11 formed in the center portions of the elastic bodies 10, the vessels 30 are then stacked inside the pieces of structural steel 70, and the concrete 40 is applied to the vessels 30 in the space 11, the present invention is not limited thereto. That is, the present invention can be implemented in the following sequence: the pieces of structural steel 70 are first installed in the vertical direction in the space 11 defined at the center portions of the elastic bodies 10, the vessels 30 are then stacked inside the pieces of structural steel 70, pieces of structural steels 70 are installed in the horizontal direction at an upper end portion and a lower end portion of the vertically installed pieces of structural steel 70, and then the concrete 40 is finally applied to the vessels 30 into the space 11.

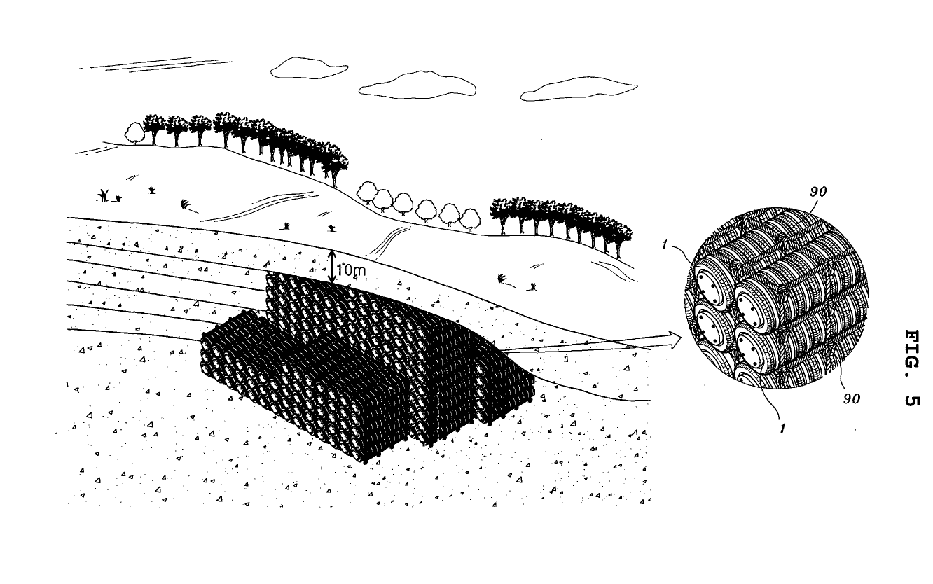

FIG. 5 is a schematic perspective view illustrating a nuclear waste disposal apparatus installed on land.

Referring to FIG. 1, 2 or 4, the nuclear waste disposal apparatus 1 comprises a plurality of stacked ring-shaped elastic bodies 10, ultra-high-strength reinforced concrete 40 applied into and cured in a space provided in the center portions of the elastic bodies 10, covers 50 provided on an upper surface of the uppermost elastic body and a lower surface of the lowermost elastic body, respectively, a waterproof agent coated on outer surfaces of the elastic bodies 10 and the covers 50, and pieces of structural steel 70 installed in the space 10 provided at the center portions of the elastic bodies 10. Referring to FIG. 5, a plurality of the nuclear waste disposal apparatuses 1 shown in FIG. 1, 2, or 4 is arranged on a clay layer 10 meters below the surface of the earth.

The nuclear waste disposal apparatus 1 is sealed by a soil mixture of clay and lime.

The soil mixture of clay and lime is rammed and topped with general soil.

A plurality of the nuclear waste disposal apparatuses 1 is connected therebetween by a metal fixing means 90. That is, the elastic bodies 10 of the adjacent apparatus 1 can be tied by a rope.

That is, after connecting the nuclear waste disposal apparatuses 1 by a rope or a metal fixing means 90, the apparatuses 1 are arranged on land.

The metal fixing means 90 is plated with titanium so as not to be corroded by groundwater.

Since the plurality of nuclear waste disposal apparatuses 1 is connected therebetween by the metal fixing means 90 to have a predetermined weight, it is capable of withstanding natural disasters that can occur on land, and prevent the apparatuses 1 from being displaced from their designated installation positions.

According to the embodiment of the present invention, the apparatuses 1 are installed on the clay layer 10 meters below the surface of the earth. Accordingly, if there is no geological clay layer in the selected nuclear waste disposal site, a clay layer must be artificially formed in the nuclear waste disposal site, so that the apparatus 1 can be installed on the clay layer.

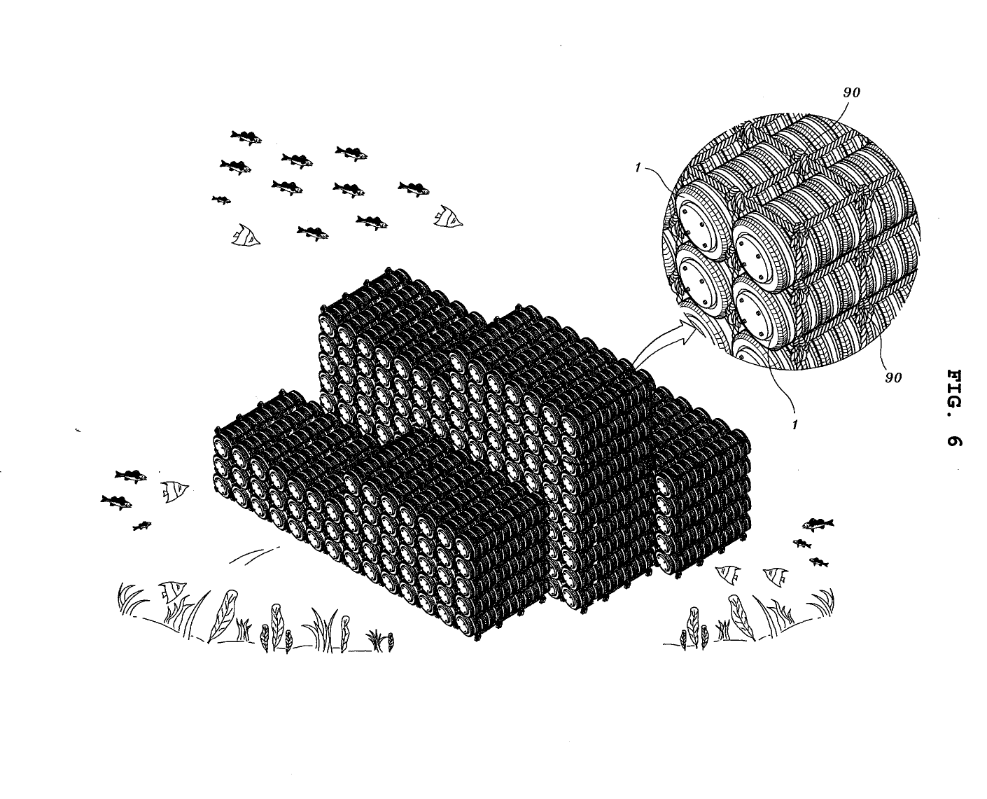

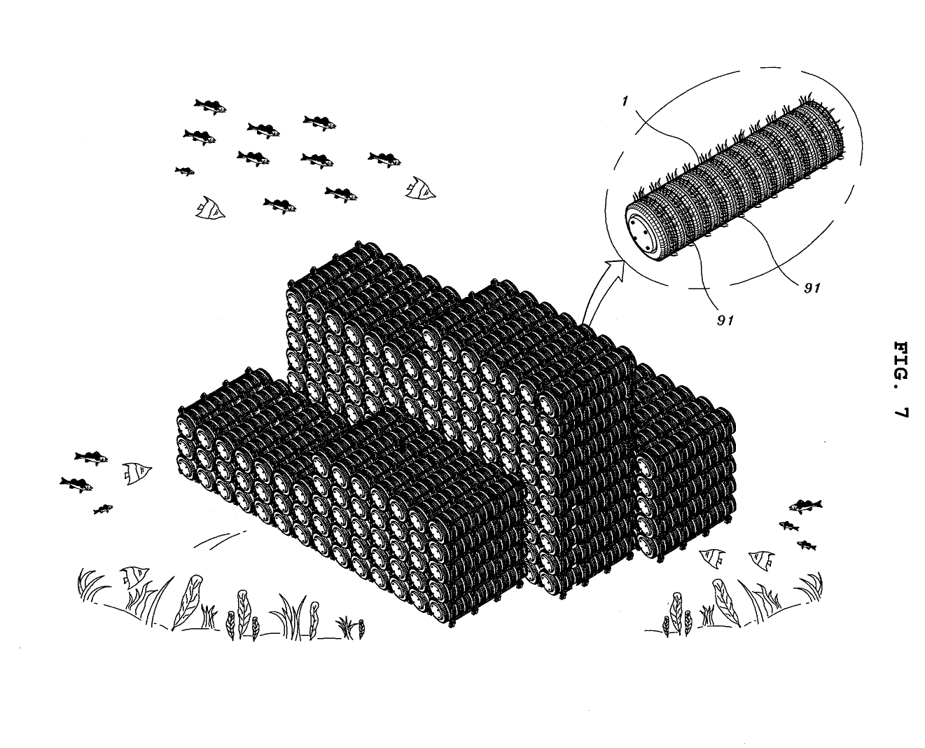

FIG. 6 is a schematic perspective view illustrating a nuclear waste disposal apparatus installed in the sea, and FIG. 7 is a perspective view illustrating a group of nuclear waste disposal apparatuses installed in the sea.

Referring to FIG. 1, 2 or 4, each nuclear waste disposal apparatus 1 comprises a plurality of stacked ring-shaped elastic bodies 10, ultra-high-strength reinforced concrete 40 applied into and cured in a space provided in the center portions of the elastic bodies 10, covers 50 provided on the upper surface of the uppermost elastic body and the lower surface of the lowermost elastic body, respectively, a waterproof agent coated on outer surfaces of the elastic bodies 10 and the covers 50, and pieces of structural steel 70 installed in the space 10 provided in the center portions of the elastic bodies 10. A plurality of the nuclear waste disposal apparatuses 1 is connected to each other with a rope and dumped in the sea.

That is, many apparatuses 1, each having vessels 30 storing nuclear waste therein, are connected by a metal fixing means 90 and then positioned at a predetermined depth of water in the sea.

At this time, the depth of water is determined to correspond to a position where fish lay eggs and inhabit. The apparatuses 1 are connected to each other by the metal fixing means 90. The metal fixing means 90 is plated with titanium so as not to be corroded by sea water.

Since the plurality of nuclear waste disposal apparatuses 1 is connected therebetween by the metal fixing means 90 to have a predetermined weight, the apparatuses 1 are not easily displaced from their original installation position by the ocean current or by the condition of the ocean.

According to the embodiment of the present invention, the apparatuses 1 are connected by the metal fixing means 90 plated with titanium, but such connection can be made by a chain or other materials, that are not corroded by sea water.

Here, the outer surfaces of the stacked elastic bodies and the covers 50 are coated with a waterproof agent 80 and then stone powder is preferably adhered thereto.

The stone powder adhered to the outer surfaces of the elastic bodies and the covers coated with a waterproof agent provides fish with habitats and provides sea weed with a place to grow, thereby generating an artificial colony of seaweed.

When the nuclear waste disposal apparatus 1 is dumped into the sea, sea water cannot permeate into the apparatus 1, and radiation from the vessel 30 is prevented.

FIG. 6 is a perspective view illustrating a seaweed colony formed on the nuclear waste disposal apparatus according to the present invention.

Referring to FIG. 1 and FIG. 2, thanks to the stone powder 91 adhered to the outer surfaces of the apparatus 1, fish habitat is provided and seaweed colonies are formed, thereby a large fishing ground is formed. As a result, fishery resources can be realized.

As described above, by using the nuclear waste disposal apparatus according to the present invention without additional facilities, the nuclear waste can be disposed of and stored in the sea and seaweed colonies can be formed, forming a large fishery. Accordingly, the apparatus according to the present invention is beneficial to future fishery resources.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A nuclear waste disposal apparatus, comprising:
a plurality of ring-shaped elastic bodies (10), each having a central hole, stacked in a vertical direction;
a plurality of vessels (30), each storing nuclear waste therein, stacked in a space provided by the central holes of the elastic bodies; and
high-strength reinforced concrete (40) charged into the space (11) in the elastic bodies (10) and cured.

2. The nuclear waste disposal apparatus according to claim 1, wherein covers (50) are respectively coupled to an upper surface of an uppermost elastic body (10) and a lower surface of a lowermost elastic body (10) by a fixing means (51).

3. The nuclear waste disposal apparatus according to claim 2, wherein outer surfaces of the elastic bodies (10) and the covers (50) are coated with a waterproof agent (80).

4. The nuclear waste disposal apparatus according to claim 2, wherein outer surfaces of the elastic bodies (10) and the covers (50) are coated with a waterproof agent (80) through a polyurea lining process.

5. The nuclear waste disposal apparatus according to claim 2, wherein outer surfaces of the elastic bodies (10) and the covers (50) are covered with stone powder.

6. The nuclear waste disposal apparatus according to claim 1, wherein the elastic body (10) is a discarded tire used on a truck or a large-sized bus.

7. The nuclear waste disposal apparatus according to claim 1, wherein a plurality of pieces of structural steel (70) is installed at edges of the space (11) of the elastic bodies (10) in the vertical direction and in the horizontal direction.

8. The nuclear waste disposal apparatus according to claim 7, wherein the pieces of structural steel (70) is coated with epoxy.

9. A method of manufacturing a nuclear waste disposal apparatus including ring-shaped elastic bodies (10), vessels (30) and high-strength reinforced concrete (40), comprising the steps of:
stacking a plurality of ring-shaped elastic bodies (10), each having a central through hole;
stacking a plurality of vessels (30), each storing nuclear waste therein, in a vertical direction in a space (11) defined by the central through holes of the elastic bodies (10), and sealing the vessels (30) by filling the space with concrete (40);
hardening and curing the concrete (40);
coupling covers (50) to an upper surface of an uppermost elastic body (10) and a lower surface of a lowermost elastic body (10), respectively by a fixing means (51); and
coating outer surfaces of the elastic bodies (10) and the covers (50) with a waterproof agent (80).

10. The method according to claim 9, further comprising the step of installing a plurality of pieces of structural steel (70) in the space (11) in the elastic bodies (10) in the vertical direction and the horizontal direction.

11. The method according to claim 9, further comprising the step of adhering stone powder onto outer surfaces of the elastic bodies (10) and the covers (50).

12. A method of installing a nuclear waste disposal apparatus including ring-shaped elastic bodies (10), vessels (30), and high-strength reinforced concrete (40), comprising the steps of:
arranging the nuclear waste disposal apparatus (1) on a clay layer 10 meters below the surface of the earth;
sealing the nuclear waste disposal apparatus (1) with a soil mixture of clay and lime; and
topping the soil mixture with general soil,
when installing the apparatus on land.

13. The method according to claim 12, further comprising the step of connecting the plurality of apparatuses (10) to each other with a metal fixing means (90).

14. A method of installing a nuclear waste disposal apparatus including ring-shaped elastic bodies (10), vessels (30), and high-strength reinforced concrete (40), comprising the steps of:
dumping the nuclear waste disposal apparatuses (1) in a sea;
arranging the nuclear waste disposal apparatuses (1) in the sea;
connecting the nuclear waste disposal apparatuses (1) to each other in the sea using a metal fixing means (90),
when installing the apparatus in sea.
